(19) United States
(12) Patent Application Publication
(10) Pub. No.: US 2004/0163711 A1
(43) Pub. Date: Aug. 26, 2004

(54) Fluid regulating pinch valve

(75) Inventors: Russell Varone, Red Lion, PA (US); Michael Deitz, Manchester, PA (US)

Correspondence Address: VENABLE, BAETJER, HOWARD AND CIVILETTI, LLP, P.O. BOX 34385, WASHINGTON, DC, 20043-9998, US

(73) Assignee: Graham Packaging Company, L.P., York, PA

(21) Appl. No.: 10/368,557

(22) Filed: Feb. 20, 2003

(51) Int. Cl. F16K 31/12

(52) U.S. Cl. 137/486

(57) ABSTRACT

An apparatus for controlling the flow of a fluid through a flexible wall tube including a body having a tubing receptacle that directs a flexible wall tube longitudinally through the body; a compression shoe; and an actuator to drive the compression shoe, such as a piston connected with a connecting pin. the apparatus can be pneumatically driven. The compression shoe has an arcuate contact surface that is curved in a longitudinal direction and substantially linear in a transverse direction. The apparatus can further include a housing, for example a cushion tube, to envelope the flexible wall tubing. A system for controlling one or more flow rates through one or mote tubes can include the valve.

### BACKGROUND OF THE INVENTION

1. Field of the Invention

The present invention is a valve for regulating the flow of a fluid through a tube. More particularly, the invention is a pinch valve for use on systems having flexible tubing.

2. Related Art

Typical valves for regulating the flow of a fluid through tubing are generally of complex construction that leads to several disadvantages. These disadvantages are accentuated in systems where the fluid which is flowing can cure to form a solid material or otherwise become more viscous and interfere with flow of non-viscous material through the valve. For example, a typical commercially available regulator valve includes a needle and seat valve assembly. Such valves are sold by, for example, ITW Ransburg under various trade names. In this type of system, the needle and seat valve are both immersed in the fluid stream. In valves such as the DR-1 (TM) fluid regulator valve by ITW Ransburg, the valve uses an air signal to move a diaphragm-mounted driving pin. The driving pin forces a spring-held ball check device off of a seat valve surface. This creates a flow channel for fluid to move through the valve. As the driving pin displacement increases, the ball check valve is pushed further off the seat, allowing flow to increase by increasing the flow area.

Such valves have several drawbacks. For example, the moving parts are immersed in the process fluid flowing through the valve. The seating surfaces have high tolerances and are subject to damage, wear and obstruction by particulate materials. In addition, these types of valves have large flow chambers which create dead spaces. In systems where the flowing material is thermosetting, these materials may accumulate and begin to cure, thereby impeding operation of the valve. Other typical drawbacks of these and similar valves are the need for multiple connections for the fluid stream at entry and exit points, which can include threaded connections where material can collect as it flows through the fluid stream and valve. In addition, multiple fluid sealing surfaces and O-rings used to prepare such valves are subjects to leaks, damage and degradation.

It is well known in the art to employ pinch valves or clamps to constrict the flow of a liquid or gas through a line of tubing. In particular, pinch valves are often used with flexible plastic or rubber tubing for the control of flow. Known pinch valves have the advantage that the valve parts are free from contamination by the process fluid and that they can be used reliably with flow material containing particulates.

Pinch valves generally employ a simpler construction than other valves used to control fluid flow through flexible tubing. Pinch valves are less costly than other known valves which require seals or the like that must resist the effects of direct exposure to the process materials such as liquids. Valves that use seals, such as those described above, require significantly more maintenance than pinch valves and are generally of a larger size making their use more cumbersome. Another advantage of pinch valves is that they can be designed to permit installation without disconnecting the tubing line. Such a feature can be a significant benefit where, in some applications, disconnection of the tubing is difficult or inconvenient. Pinch valves are typically, however, of the on/off type only, although some provide a means to vary the flow of material through the tubing. Variation of flow may be either continuous or incremental between the fully open and fully closed positions.

For example, a known type of pinch valve, a type 25R manufactured by Research Control Valves, uses a spherical ball to compress the tubing line. The ball is pushed, not rotated, into and against the wall of the tubing. External energy is required to maintain the spherical ball in its valve position. Such an apparatus is very bulky and is not appropriate for use with smaller sized tubing. The spherical ball valve apparatus is well suited for on/off applications but since it is devoid of any calibration, it is poorly suited for incremental flow control.

Known types of clamps have similar disadvantages as the pinch valves described above. For example, a KECK Ramp Clamp provides no calibration and has low mechanical advantage so its application is limited to a small range of tubing wall thickness and size. A compression of the tubing is required so true full flow cannot be realized. KECK Ramp Clamps are not suitable for manufacture in materials other than plastic nor vacuum applications.

Although these valves provide some advantages, the need still remains for a pinch valve that can operate over a wider range of tubing flexibilities which ultimately results in a wider range of pressure and vacuum conditions. There is a need to combine those advantages with the ability to adjust valve settings with accuracy. Tubing used for some applications can have relatively thick walls, or may have limited resiliency, requiring more force to squeeze the tubing closed.

There is thus a continued need for a valve that overcomes shortcomings of conventional solutions.

### BRIEF SUMMARY OF THE INVENTION

In summary, the valve of the present invention is a pinch valve suitable for use on tubing with low resiliency. The valve allows fine control of flow and therefore have use in a wide range of applications.

This invention solves a problem previously thought to be insoluble. Pinch valves are typically inappropriate for use with tubing that has limited resiliency. The present invention can be used with such tubings and provide fine control of flow rates.

An apparatus for controlling the flow of a fluid through a flexible wall tube according to the invention includes a body having a tubing receptacle that directs a flexible wall tube longitudinally through the body; a compression shoe; and an actuator to drive the compression shoe, such as a piston connected with a connecting pin. Movement of the piston is controlled by a drive mechanism, that, in exemplary embodiments, is pneumatically driven. The compression shoe has an arcuate contact surface that is curved in a longitudinal direction and substantially linear in a transverse direction. Activating the actuator moves the compression shoe to compress the tube and control the flow of fluid through the tube. The apparatus can also include a guiding structure to maintain alignment of the compression shoe in the body, such as a guide rod connected to the compression shoe and the body, that slides up and down the body. A spring or other means for applying a linear acting force opposing the actuator force can be attached to the compression shoe to apply force in a direction opposite to force applied by the actuator. Other means for applying an opposing force include, but are not limited to, a pressurized gas bladder, elastomeric bushings and the like. The spring can be located, for example, around the guide rod. The hollow body can be made up of two pieces, a first body part and a tubing saddle, where the tubing saddle includes a tubing guide with the tubing receptacle is formed at the junction of the tubing saddle and the upper body part. The apparatus can further include a housing, for example a cushion tube, to envelope the flexible wall tubing.

In another aspect, the invention is a system for controlling flow of a fluid through a flexible wall tube that includes a flow meter for measuring a flow rate of the fluid through the flexible wall tube; a valve as described herein and a controller, wherein said controller adjusts flow rates through the tubing to a predetermined valve by variably actuating said actuator in response to a measurement of flow rate by the flow meter. The valve may be controlled pneumatically by providing variable air pressure to the actuator drive mechanism. The system can include more than one valve. Where multiple flows are controlled, the system can further include a mixing valve and a system monitor, also connected to the controller, to monitor the mixed effluent. The controller can than maintain a mixed effluent in a predetermined ratio or with predetermined properties.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 is a plan view of an exemplary embodiment of a regulating valve according to the present invention;

FIGS. 2A-2C depict an exemplary embodiment of an upper body part according the present invention;

FIG. 3 depicts an exemplary embodiment of a tubing saddle according to the present invention;

FIGS. 4A-4C depict an exemplary embodiment of a compression shoe according to the invention;

FIG. 5 depicts a guide pin according the present invention; and

FIG. 6 depicts a system comprising the valve of the present invention.

### DETAILED DESCRIPTION OF THE INVENTION

Embodiments of the invention are discussed in detail below. While specific exemplary embodiments are discussed, it should be understood that this is done for illustration purposes only. In describing embodiments, specific terminology is employed for the sake of clarity. However, the invention is not intended to be limited to the specific terminology so selected. A person skilled in the relevant art will recognize that other components and configurations can be used without parting from the spirit and scope of the invention. All references cited herein are incorporated by reference as if each had been individually incorporated.

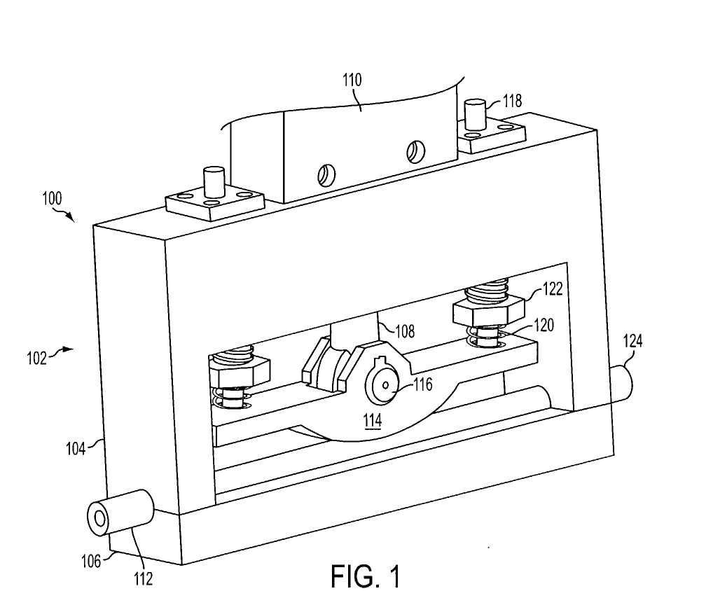

The present invention is a pinch valve 100 used to regulate the flow of a material through a flexible tube. The present invention is particularly useful for regulating a flow of coating materials being supplied to a coating applicator, although it will be appreciated that as there are many other uses for the invention. As depicted in the exemplary embodiment shown in FIG. 1, the invention includes a general hollow body 102 which can include an upper body block 104 and a lower body block or tubing saddle 106. In addition, the invention includes an actuator, for example an actuator piston 108, driven by an actuator drive mechanism 110. The body 102 also includes a tubing receptacle 112 which, in the embodiment shown, consists of a hole through which tubing may be directed. The tubing receptacle 112 directs the tubing longitudinally through the valve 100. The valve 100 includes a compression shoe 114 which can move up and down within the hollow portion of the body 102. As used herein, “down” refers to a direction which would move the compression shoe 114 into engagement with the tubing being fed through the tubing receptacle 112; and, “up” refers to a direction which would move the compression shoe 114 in a direction away from the tubing. The compression shoe 114 can be connected to the actuator piston 108 by any suitable mechanism. In the embodiment depicted in FIG. 1, the actuator piston 108 is connected to the compression shoe 114 by use of a connecting pin 116.

The embodiment of FIG. 1 includes further elements which (a) generally assist maintaining the movement of the compression shoe 114 in an up and down motion and (b) provide a linear force in a direction opposite to the force applied by the actuator piston 108 as described further below. In the embodiment depicted, the system for maintaining the directionality of the movement of the compression shoe 114 consists of a pair of guide rods 118 that are connected to the compression shoe 114 and slide up and down in a receptacle of the body 102. On the outside of each of the guide rods 118 within the hollow portion of the body 102 is a spring 120. An adjustment screw 122 is located over the guide rod 118. In the embodiment shown, the threads on the adjustment screw 122 fit into a threaded receptacle of the hollow body 102. The adjustment screw 122 can be extended from the body 102 to increase tension on the spring 120, or screwed into the body 102 to decrease tension on the spring 120. The guide rods 118 extend through the spring and connect to the compression shoe 114. The spring 120 provides a linear acting opposing force in a direction opposite to the force applied by the actuator piston 108.

The valve of the invention can be designed to have a “normally closed” or a “normally open” configuration. In a “normally closed” configuration, when a force from the actuator piston 108 is absent, the springs 120 apply a force to maintain the valve to a closed position providing a complete shut off of material flow through the tubing in the event of control system failure. In a “normally open” configuration, the springs 120 apply a force to maintain the valve in an open position when no force is applied by the actuator piston 108. Thus, in the event of control system or signal failure, the valve is maintained in an open position. The choice of having a “normally closed” or “normally open” configuration depends on the particular application and can be readily made by persons skilled in the art.

In an exemplary embodiment, of a “normally closed” configuration, the springs 120 apply a force pushing the compression shoe 114 down on the tubing. Activation of the actuator piston 108 through the actuator drive mechanism 110 moves the compression shoe 114 up and away from the tubing. This would result in compression of the springs 120 so that, when the actuator drive mechanism 110 stops acting on the actuator piston 108, the compression shoe 114 is driven towards the tubing.

In an example of a “normally open” configuration, the actuator drive mechanism 110 moves the actuator piston 108 in a down direction. The springs 120 apply a force moving the compression shoe 114 up, i.e. away from the tubing. Activating the actuator piston 108 moves the compression shoe 114 towards the tubing, extending the springs 120. When the compression shoe 114 is the fully down position, the springs 120 are fully extended thus providing a force that would, absent other forces, pull the compression shoe 114 up and away from the tubing. In this system, when the actuator drive mechanism 110 stops acting on the actuator piston 108, the force provided by the springs 120 takes over and the compression shoe 114 moves away from the tubing.

Means other than springs 120 may be used to apply a force to the compression shoe 114 opposed to the force applied by the actuator. All that is required is that the force be a linear counteracting force to the force applied by the actuator piston 108. Example of other means for applying a force include, but are not limited to a pressurized gas bladder and an elastomeric bushing. Other means will be known to persons skilled in the art.

The valve 100 of the present invention can include a housing for the flexible tubing such as a cushion tube 124. The cushion tube 124 is a cylindrical member which consists of a piece of flexible tubing with an inner diameter large enough to receive flexible system tubing of a certain smaller outer diameter. The system tubing fits within the cushion tube 124. The cushion tube 124 can be a split tube which can be placed around the system tubing or can be a solid piece of tubing through which the system tubing is fed when incorporating the valve 100 of the invention into the system.

Use of cushion tube 124 offers several advantages over a system having direct contact of the contact surface 402 of the compression shoe 104 with the flexible system tubing. First, use of a cushion tube 124 insulates the system tubing from direct exposure to the contact surface 402 of the compression shoe 114 and the valve body 102. This helps the fluid line maintain the structural integrity of the system tubing under typical working loads. As a result, the system tubing can be replaced less frequently, thus reducing maintenance costs. Another advantage to the use of a cushion tube 122 is that it allows the use of system tubing made of materials not typically amenable for use with a pinch valve. For example, Teflon and other fluoropolymers typically have very poor resiliency properties and tend to be crushed by typical pinch valves. By use of the present valve 100 with a cushion tube 122, flow through such less resilient tubing may be regulated without the problem of system tubing collapse, which has been observed in the prior art.

As will be appreciated by persons skilled in the art, features for maintaining the directionality of compression shoe 114 movement are not limited to the use of guide rods. Any suitable arrangements may be used. For example, slots formed in the sidewalls of the body 102 could engage projections on the ends of the compression shoe 114. The springs or other devices for applying a force opposing the actuator force can be loaded into the slots which would then provide the motive force in a direction opposite to that of the actuator piston 108. Persons skilled in the art will realize other arrangements that exist.

The actuator drive mechanism 110 used to drive the actuator piston 108 can be of any type known in the art. For example, the actuator drive mechanism 110 can comprise a gear which engages a thread or cylindrical projection on the actuator piston 108. In an exemplary embodiment of the invention, the actuator drive mechanism 110 is a pneumatic system for placing pressure on the actuator piston 108. When the actuator drive mechanism 110 is a pneumatic drive device, air pressure fed into the actuator drive mechanism 110 can provide the motive force to the actuator piston 108. As will be described further below, the actuator drive mechanism 110 can be controlled by a suitable control mechanism.

The actuator device is similarly not limited to a piston. Any mechanism may be used to move the compression shoe 114 up and down within the hollow body 102. These can push or pull the compression shoe 114 towards the tubing or push or pull the compression shoe 114 away from the tubing.

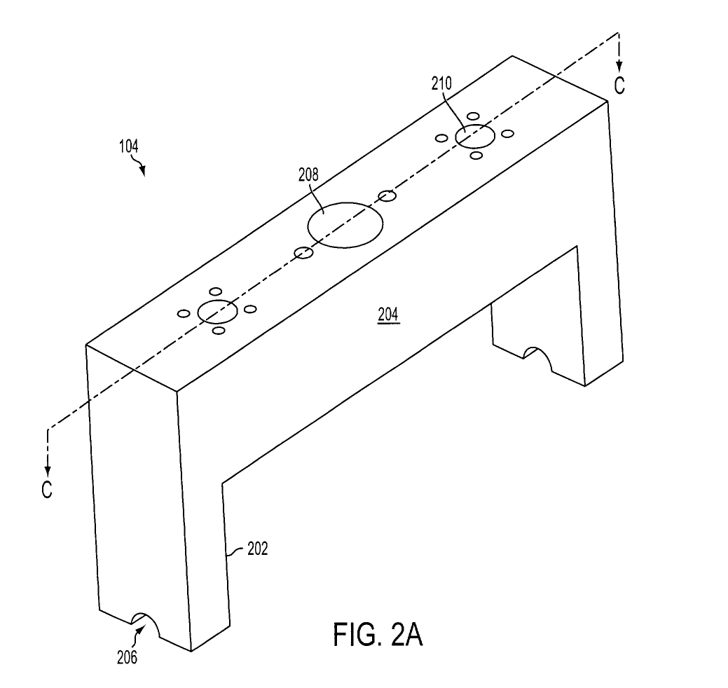

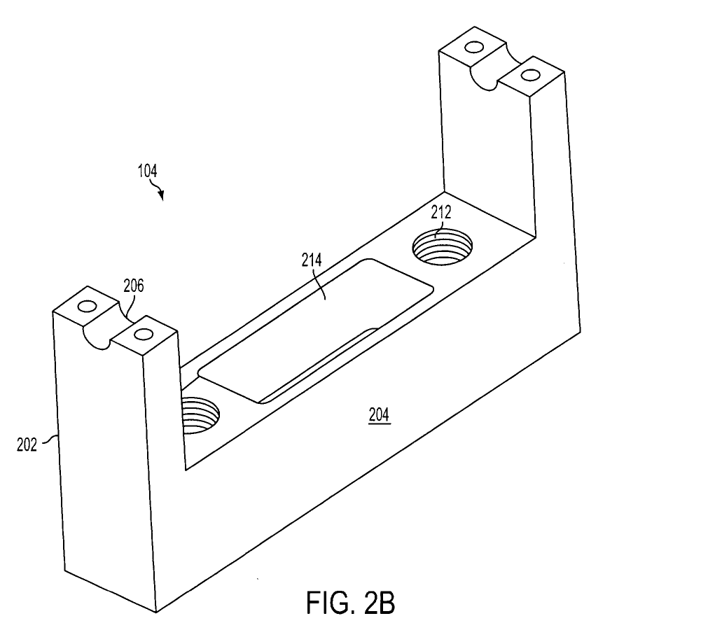

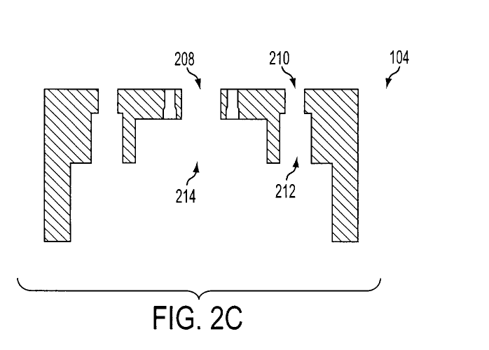

As indicated above, the body of the valve 100 of the invention can comprise two parts: an upper body part 104 and a tubing saddle 106. FIG. 2A is an upper plan view of an upper body part 104 according to this embodiment of the invention. As shown in FIG. 2A, the upper body part 104 can comprise a pair of upper body block legs 202 which extend from an upper body block cross member 204 to the connecting point with the tubing saddle 106. At the end of the upper body block leg 202 and distal to the cross member 204, is a cut-out 206 corresponding to the upper part of the tubing receptacle 112. FIG. 2A further depicts a piston guide 208 and openings for the guide rod 210. FIG. 2B depicts a bottom plan view of the upper body block 106 of FIG. 2A. The tubing receptacle cuts out 206 are easily seen in the lower plan view of FIG. 2B. As is also seen in FIG. 2B, the bottom side of the opening 210 for the guide rod 118 consists of an adjustment screw receptacle 212 which is a larger diameter than the guide rod opening 210. This larger diameter opening can include threads for accepting the corresponding threads of the adjustment screw 122. Similarly, the cross member 204 can include an actuator piston receptacle 214 that is larger than the piston guide 208. This allows for some back and forth motion of the piston as well as reducing the surface area which might cause frictional force on degradation of the actuator piston 108.

FIG. 2C is a cross-sectional view of the upper body block 104 taken along the C-C line of FIG. 2A. FIG. 2C shows the spatial relationship of the piston guide 208 and piston receptacle 214, as well as the guide rod opening 210 and the threaded adjustment screw receptacle 212.

FIG. 3 shows an upper plan view of a tubing saddle 106 according to an embodiment of the invention wherein the body 102 comprises two pieces. As can be seen in FIG. 3, there is a channel 302 longitudinally directed along the tubing saddle 106 which acts as a tubing guide. At the end of the tubing saddle 106, the channel 302, together with the cutout 206 of the upper body block 104, forms the tubing receptacle 112.

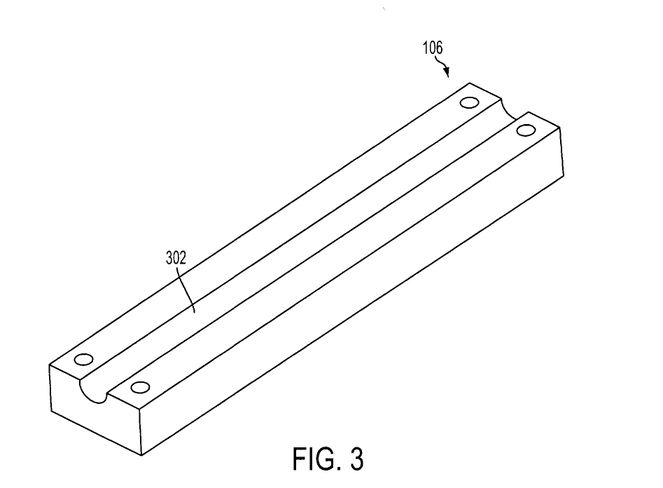

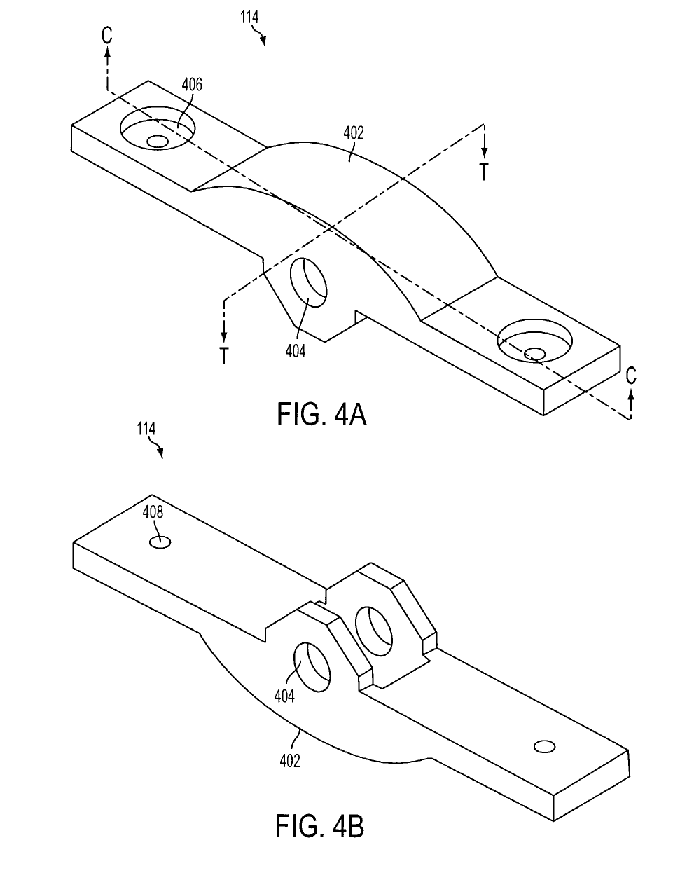

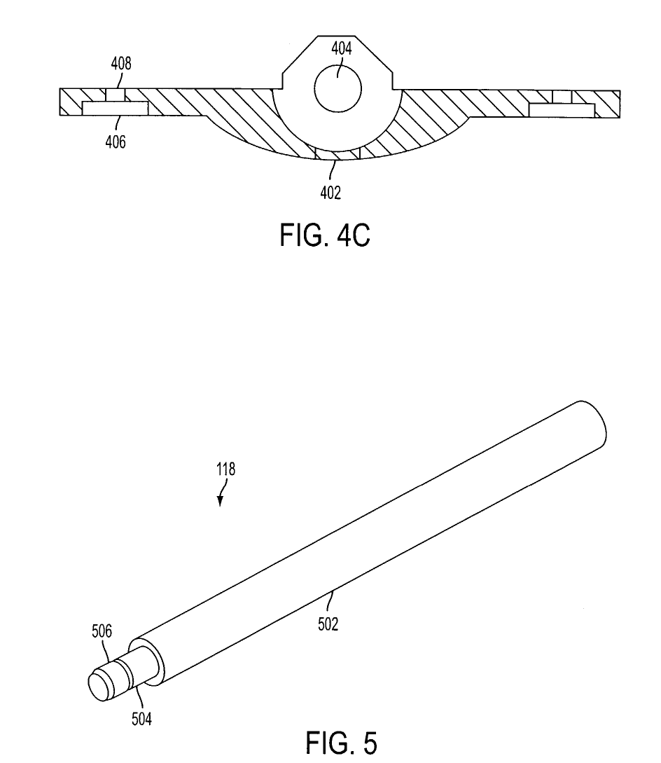

FIGS. 4A and 4B depict bottom and top plan views, respectively, of the compression shoe 114. The compression shoe 114 includes a contact surface 402 which is a contoured member that can transfer force to the flexible system tube in the channel 302 of the valve 100. The contact surface 402 is shaped to provide a variable geometry contact area with the tubing. As the compression shoe 114 is driven downward, an increasing surface area of the contact surface 402 contacts the tubing. This variable contact area provides greater resolution of a force placed on the system tubing than would a fixed contact area such as, for example, a flat plate. As used here, resolution of the force means the ability to finely control the total force applied to the tubing and, consequently, flow rate of a fluid flowing through the tubing. As can be seen in FIGS. 1 and 4A, the contact surface of the 402 of the compression shoe 114 is curved in the longitudinal direction. FIG. 4C is a cross-sectional longitudinal view through the compression shoe 114 taken through the B-B line of FIG. 4A. The arcuate contact surface is more clearly shown this in longitudinal cross-section. If viewed in transverse section, i.e., along the T-T line of FIG. 4A, however, the contact surface 402 is generally linear, but can have some curvature.

FIG. 4A also shows that the compression shoe 114 includes a connector pin receptacle 404 which can be used in embodiments where an actuator piston 108 is connected to the compression shoe 114 through a connector pin 116. On the lower surface of the compression shoe 104 depicted in FIG. 4A is a guide rod seat 406. FIG. 4B shows a guide rod pin receptacle 408 located on the top surface of the compression shoe 114. The guide rod seat 406 is of a larger diameter than the guide rod pin receptacle 408 shown in FIG. 4B. FIG. 4C shows the relationship between the guide rod pin receptacle 408 and the guide rod seat 406.

FIG. 5 depicts an exemplary guide rod 118. The guide rod 118 consists of a body 502 which terminates in a pin 504 having a smaller diameter that can fit through the guide rod pin receptacle 408 in the compression shoe 114. The pin 504 includes a groove 506 that can accommodate a snap ring sealing device for connecting the guide rod 118 to the compression shoe 114. When the pin 504 is fed through the guide pin receptacle 408 and the snap ring put on, the snap ring can fit into the guide rod seat 406. Thus the guide rod pin and snap ring do not protrude beyond the surface of the compression shoe 114.

The valve 100 of the present invention can be constructed from a wide variety of materials. For example, the valve 100 may be cast from aluminum or other light weight metal or can be made of molded plastic. T-6 aluminum is an exemplary type of aluminum suitable for value construction. Alternatively, most parts of the present invention may be made from a molded plastic, for example, nylon, polyester, polyurethane, or other suitable materials. Of course, certain components, for example, springs 114 may be made from metals or other materials. Depending on the force needed to be applied, however, springs of materials such as plastic may be adequate and suitable.

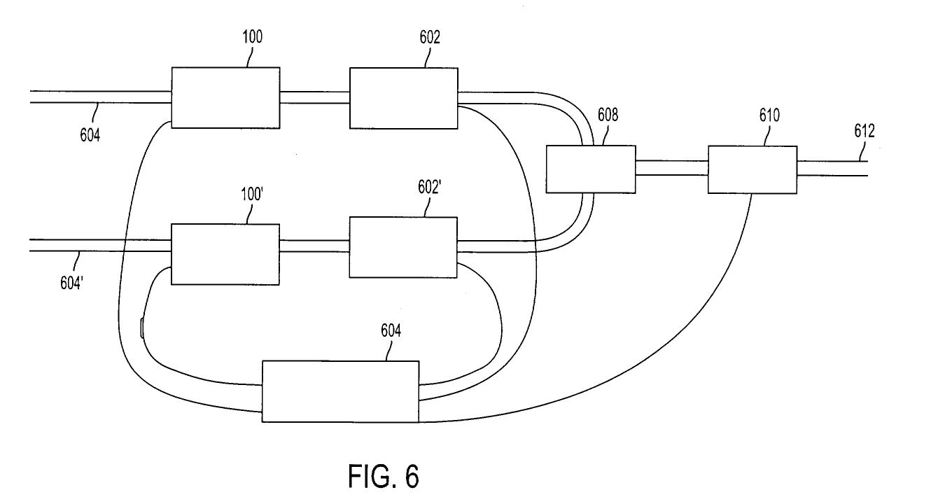

The valve 100 is useful in flow systems requiring control of flow rate. FIG. 6 depicts a system that includes the valve 100 of the invention. Such a system can comprise a flow meter 602 for measuring flow through flexible wall tubing 604. A controller 606 can be connected to the valve 100 and flow meter 602 for controlling the actuator drive mechanism 110 of the valve 100 and hence the compression shoe 114 motion and rate of flow through the system. In such an embodiment, a desired flow rate is predetermined. The flow meter 602 measures the actual rate of flow of a fluid through the system tubing 604 and provides a measure of the flow rate to the controller 606. The controller 606 then adjusts the valves 100 by controlling the actuator drive mechanism 110 as necessary to maintain the predetermined flow rate. The valve 100 may be controlled by the controller 606 by, for example, an increase or decrease in air pressure when the actuator drive mechanism 110 of the present invention comprises a pneumatically controlled device.

The system can also be used in applications where two or more fluids are flowing through two or more lines as shown in FIG. 6. Fluid flow through system tubings 604, 604′ each of which is directed through a valve 100, 100′ and flow meter 602, 602′. Each of the flow meters 602, 602′ is connected to the controller 606. The valves 100, 100′ are controlled by, for example, controlling the pneumatic pressure to the actuator drive mechanisms of the valves 100, 100′. In this way, the proper rate of flow for the several components may be monitored and controlled. For example, it may be desirable to control the rates of flow of two fluids to be identical or at some a certain ratio.

The system of the present invention can further include a mixing valve 608, particularly when more than one component is being used. A secondary system monitor 610 may provide information about the mixed fluid stream flowing through an exit tube 612. This information can then be fed back into the controller 606. The controller 606 can provide signals or, for example, air to control the valves 100, 100′ hence regulating fluid flow which continues to be monitored through the flow meters 602, 602′. In this way, the controller 606 receives information regarding composition of fluid flowing through the exit tube 612 and can adjust the flow of constituents accordingly. The controller 606 thus sets the predetermined flow rate to be measured by the flow meters 602, 602′.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. An apparatus for controlling the flow of a fluid through a flexible wall tube comprising:
a body comprising a tubing receptacle for directing the flexible wall tube longitudinally through said body;
a compression shoe comprising an arcuate contact surface, said surface being curved in a longitudinal direction of said compression shoe and substantially linear in a transverse direction of said compression shoe; and
an actuator movably connecting said compression shoe to said body,
wherein activating said actuator moves said compression shoe for compressing the tube to control the flow of fluid through the tube.

2. The apparatus of claim 1, further comprising a guiding structure.

3. The apparatus of claim 2, wherein the guiding structure comprises a guide rod connected to said compression shoe and slideable connected to said body.

4. The apparatus of claim 1, further comprising a means for applying a force to said compression shoe in a direction opposite a force applied by said actuator.

5. The apparatus of claim 4, wherein said means for applying a force is selected from a spring, a gas bladder and an elastomeric bushing.

6. The apparatus of claim 5, said means for applying a force comprising a spring and further comprising an adjustment screw for adjusting tension on said spring.

7. The apparatus of claim 3, further comprising a spring around said guide rod to apply a force to said compression shoe in a direction opposite a force applied by said actuator.

8. The apparatus of claim 1, wherein the body comprises a first body part and a tubing saddle, said tubing saddle comprising a tubing guide.

9. The apparatus of claim 8, wherein the tubing receptacle is formed at the junction of the tubing saddle and the upper body part.

10. The apparatus of claim 1, further comprising a housing, said housing adapted to envelope the flexible wall tubing.

11. The apparatus of claim 10, wherein said housing comprises a cushion tube.

12. The apparatus of claim 1, wherein said actuator comprises a piston.

13. The apparatus of claim 12, wherein movement of said piston is controlled by a drive mechanism.

14. The apparatus of claim 13, wherein said drive mechanism is pneumatically driven.

15. An apparatus for controlling the flow of a fluid through a flexible wall tube comprising:
a body comprising a first body part and a tubing saddle, said first body part and said tubing saddle cooperating to define a tubing receptacle for directing the flexible wall tube longitudinally thorough said body, and said tubing saddle comprising a tubing guide, wherein said tubing guide is open on a side in a direction toward a compression shoe; and
a compression shoe comprising a contact saddle having an arcuate contact surface, said surface being curved in a longitudinal direction of said compression shoe and substantially linear in a transverse direction of said compression tube,
an actuator comprising an actuator piston connected to said compression shoe and a drive mechanism connected to said piston and said body, wherein activating said drive mechanism moves said piston;
a guide rod connected to said compression shoe and slidably connected to said body;
a spring connected to said first body part and said compression shoe around said guide rod; and
said piston and said spring cooperate to move said compression shoe for compressing the tube to control the flow of fluid through the tube.

16. The apparatus of claim 15, further comprising a cushion tubing.

17. The apparatus of claim 15, wherein said apparatus is pneumatically controllable.

18. The apparatus of claim 15, wherein said apparatus is made from aluminum.

19. The apparatus of claim 15, wherein said actuator piston is connected to said compression shoe by a connecting pin.

20. A system for controlling flow of a fluid through a flexible wall tube, said system comprising
a flow meter for measuring a flow rate of the fluid through the flexible wall tube;
a valve, said valve comprising a body comprising
a tubing receptacle for directing the flexible wall tube longitudinally thorough said body;
a compression shoe comprising an arcuate contact surface, said surface being curved in a longitudinal direction of said compression shoe and substantially linear in a transverse direction of said compression shoe; and
an actuator movably connecting said compression shoe to said body,
wherein activating said actuator moves said compression shoe for compressing the tube to control the flow of fluid through the tube; and
a controller, wherein said controller adjusts flow rates through the tubing to a predetermined valve by variably actuating said actuator in response to a measurement of flow rate by the flow meter.

21. The system of claim 20, wherein said variably activating comprises pneumatically controlling the valves by providing variable air pressure to an a actuator drive mechanism attached to said actuator.

22. The system of claim 20, comprising more than one valve.

23. The system of claim 22, further comprising a mixing valve for mixing more than fluid from said more then one valve.

24. The system of claim 22, further comprising system monitor connected to said controller.

25. The system of claim 24, said controller and said system monitor cooperating to determine said predetermined valve.
